(19) United States
(12) Patent Application Publication
(10) Pub. No.: US 2008/0294940 A1
(43) Pub. Date: Nov. 27, 2008

(54) METHOD AND DEVICE FOR MANAGING COMPUTING SYSTEM

(76) Inventors: Futoshi HAGA, Sagamihara (JP); Hiroyuki Osaki, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/123,716

(22) Filed: May 20, 2008

(30) Foreign Application Priority Data
May 21, 2007 (JP) 2007-134674

(51) Int. Cl. G06F 11/07

(52) U.S. Cl. 714/37; 714/E11.021

(57) ABSTRACT

In a computing system comprising plural processor modules possessing plural processors, plural I/O devices serving as an interface of communication between the plural processor modules and external equipment, and a connection mechanism possessing plural switching units to which the plural processor modules and the plural I/O devices are coupled, the plural switching units possessed by the connection mechanism are managed as a network. In particular, the management information which defines each of plural paths by a line of two or more switching units among the plural switching units is acquired, the path status on the plural paths is grasped by analyzing the acquired management information, and the path status information on the grasped path status is created and outputted.

### CLAIM OF PRIORITY

The present application claims priority from Japanese application serial no. JP2007-134674, filed on May 21, 2007, the content of which is hereby incorporated by reference into this application

### BACKGROUND OF THE INVENTION

The present invention relates to an art for managing a computing system.

A computing system which processes an essential task, for example, is required to provide service which is available for 24 hours a day and 365 days a year. In such a computing system, when a failure occurs in a device which constitutes the system (for example, hardware such as a CPU and a memory), it is necessary to exchange a failure place (a device in which the failure has occurred, in the present example), and to restore the service as quickly as possible. However, the service restoration processing by man accompanying the exchange and resetting of the device requires a long time, and there is possibility of introducing further delay due to a human error.

As one of the measures for the case, the following technique may be employed in some instances. That is, a spare device, or a pool device, prepared to a device for which failure is expected is introduced in the computing system in advance, and when failure occurs in the device under operation, the failure device is changed to the pool device by an automatic processing.

By employing such technique, it can lessen the case to occur where the failure place needs to be exchanged with accompanying service stop. On the one hand, however, it is difficult to specify timing when the failure place is to be exchanged, requiring improvement in the management engineering of the computing system.

As management engineering of the computing system, Document 1 (JP-2004-326809 A) and Document 2 (JP-2006-268521 A) are known, for example.

Document 1 disclosed an art for verifying whether a hot-pluggable component is broken or not when it is coupled to a computing system, for example.

Document 2 discloses an art for confirming periodically operation of a spare CELL (a board in which a CPU and a main storage device (for example, memory) are implemented) which is coupled to the computing system but not used currently, for example, using the scheme of a BIOS boot.

By employing such arts, when a hot-pluggable component or a spare CELL breaks down, the situation of the failure can be grasped.

### SUMMARY OF THE INVENTION

In order to reduce the stop time length of a computing system as short as possible, exchange of the failed object by stopping the computing system should be avoided if possible. However, when the situation is one where the computing system will fail soon if the failed object is not exchanged, the failed object should be exchanged promptly. Therefore, it is desirable to determine suitable timing when the failed object is to be exchanged. In the art disclosed by Document 1 and Document 2 mentioned above, a failed object can be specified; however, a manager cannot judge suitable exchange timing for the failed object.

The present invention has been made in view of the above circumstances and provides a method and a device for managing computing system in which a manager can judge the suitable exchange timing of a failed object.

In a computing system including a processor module possessing a processor, an I/O (input/output) device serving as a communication interface between the processor module and external equipment, and a connection mechanism possessing plural switching units to which the processor module and the I/O device are coupled, the plural switching units possessed by the connection mechanism are managed as a network. To be specific, management information which defines each of plural paths by a line of two or more switching units among the plural switching units is acquired, path status about the plural paths is grasped by analyzing the acquired management information, and path status information about the grasped path status is created and outputted.

### BRIEF DESCRIPTION OF THE DRAWINGS

Embodiments of the present invention will be described in detail based on the following figures, wherein:

FIG. 1 is a diagram illustrating an example of constitution of a management system and a computing system according to one embodiment of the present invention;

FIG. 2 is a chart illustrating an example of constitution of OS area specification information 200;

FIG. 3 is a flow chart illustrating a flow of processing performed by an I/O path evaluating unit 123 upon receiving the OS area specification information 200;

FIG. 4 is a flow chart illustrating a flow of the processing performed at Step S304 of FIG. 3;

FIG. 5 is a flow chart illustrating a flow of the processing performed at Step S305 of FIG. 3;

FIG. 6 is a chart illustrating an example of constitution of I/O node information 600;

FIG. 7 is a chart illustrating an example of constitution of I/O path information 700;

FIG. 8 is a chart illustrating an example of constitution of OS area information 800;

FIG. 9 is a chart illustrating an example of constitution of I/O path evaluation result information 900;

FIG. 10 is a chart illustrating an example of constitution of I/O path information 1000 for the CPU concerned;

FIG. 11 is a chart illustrating an example of constitution of I/O node information 1100 for the CPU concerned;

FIG. 12 is a diagram illustrating an example of entire constitution of an internal network in a computing system 102; and

FIG. 13 is a diagram illustrating a part of the constitution of the internal network shown in FIG. 12.

### DESCRIPTION OF THE PREFERRED EMBODIMENTS

According to one embodiment, a management device is provided for managing the computing system mentioned above. The management device includes an acquisition unit which is operable to acquire management information on plural paths, each defined by a line of two or more switching units among plural switching units, a grasping unit which is operable to grasp path status by analyzing the acquired management information, and to create path status information on the grasped path status, and an output unit which is operable to output the path status information. The output unit may transmit the path status information to a remote communication terminal which possesses a display device, for example, and the communication terminal may display the path status information on the display device. Alternatively, the management device may possess a display device, for example, and the output unit may display the path status information on the display device. The output unit may output the path status information by voice.

The computing system may include plural pieces of at least one of a processor, a processor module, and an I/O device.

According to one embodiment, the above-mentioned management information includes information indicating which processor is associated with which path and information indicating a state of each path. The grasping unit can grasp redundancy based on the state of the path associated with the processor as the path status on a processor (for example, a processor specified based on information inputted by a manager), and can create information including the redundancy as the path status information. Specifically, the grasping unit can grasp at least one of the number of failed state paths associated with the processor specified as described above, and the number of usable state paths associated with the processor, for example. The grasping unit can create, as the path status information, information including at least one of the number of failed state paths, the number of usable state paths, and the ratio of the number of usable state paths to the sum total of the number of failed state paths and the number of the usable state paths.

According to one embodiment, a usable state path includes a used state path and an unused state path. The unused state path can be switched to a used state path, when a used state path becomes a failed state path. The grasping unit can grasp, as the path status, a number of partially shared paths associated with the processor specified above, and can create, as the path status information, information further including the number of partially shared paths. The partially shared path is an unused state path associated with a processor (for example, the processor specified above), and belongs to a switching unit which a used state path belongs to, the used state path being associated with the processor specified above and an unrelated processor.

The unrelated processor is a processor assigned to a computation region different from a computation region assigned to the processor specified above, for example. The computation region is the entire or a part of the plural processor modules.

According to one embodiment, the grasping unit can calculate a number of usable affiliation paths, that is, a number of usable state paths which each switching unit belongs to and which are associated with a processor, separately for each switching unit belonging to each path associated with the processor (for example, the processor specified above). Consequently, the grasping unit can create, as the path status information, information including an SPOF number (a number of single point of failure) defined by a number of switching units for which the number of usable state paths agrees with the number of usable affiliation paths calculated.

According to one embodiment, the management information includes information indicating a state of each path of the plural paths, and information indicating a line of two or more switching units belonging to each path. The grasping unit can create path information for a processor (for example, the processor specified above), and switching unit information for the processor based on the path management information. The path information includes information indicating a state of each path associated with the processor and information indicating two or more affiliate switching units. The switching unit information includes a state of each path to which each switching unit belongs and a number of usable affiliation paths calculated from the state of each path, for each switching unit specified by the path information.

According to one embodiment, the management information includes information indicating which path a processor is associated with, and information indicating a state of each path. The grasping unit can calculate, as the path status, a number of usable affiliation paths, that is, a number of usable state paths which each switching unit belongs to and which is associated with the processor, separately for each switching unit belonging to each path associated with the processor. Consequently, the grasping unit can create, as the path status information, information including an SPOF number defined by a number of switching units for which the number of usable state paths agrees with the number of usable affiliation paths calculated.

According to one embodiment, the above-mentioned connection mechanism is a switching device, and the plural switching units can be used as plural switch-functioning components which constitute the switching device.

Two or more embodiments out of the plural embodiments mentioned above can be combined. It is also possible to build a computing system with a function manager by having each of the above-mentioned units (the acquisition unit, the grasping unit, and the output unit) built in the computing system. Furthermore, each of the above-mentioned units (the acquisition unit, the grasping unit, and the output unit) can be built with hardware, a computer program, or the combination of them (for example, realizing a part by a computer program and the remainder by hardware). The computer program is read into a predetermined processor and executed. In the case of the information processing performed by reading the computer program into the processor, a storage area which exists on hardware resources, such as a memory, may be used suitably. The computer program may be installed in the computer from recording media, such as CD-ROM, or alternatively may be downloaded to the computer via a communication network.

Hereinafter, one embodiment of the present invention will be explained in detail with reference to the accompanying drawings.

FIG. 1 is a diagram illustrating an example of constitution of a management system and a computing system according to one embodiment of the present invention.

A computing system 102 is a computing device including one or more CPU modules 105, one or more I/O (Input/Output) devices 111, and one or more I/O path switchover devices 108. Various services are provided by the computing system 102 by loading various programs to the one or more CPU modules 105.

The CPU module 105 is a main processing device used for providing the above-mentioned services. The CPU module 105 includes one or more CPUs 106 and one or more memories 107. The CPU module 105 is coupled, via one or more I/O path switchover devices 108, to an I/O device 111 in a mutual manner (in other words, in a communicatable manner). The CPU 106 is a processor such as a central processing unit and a micro-processor in the computing system 102. The memory 107 is a main storage device in the computing system 102.

The I/O path switchover device 108 is a switching device (for example, a circuit board) which couples the CPU module 105 and the I/O device 111 in a communicatable manner. The I/O path switchover device 108 possesses plural ports. Among the plural ports, a port 109 is coupled to the CPU module 105, and a port 110 is coupled to the I/O device 111. Hereinafter, for convenience, the port 109 may be called an “upper port 109” and the port 110 may be called a “lower port 110.” The connection between the upper port 109 and the lower port 110 can be considered as a network as will be described later. The upper port 109 and the lower port 110 are coupled to the network (hereinafter called an internal network), therefore, allowing a part or all of the CPU modules 105 and a part or all of the I/O devices 111 to be coupled mutually.

The I/O device 111 couples the computing system 102 to external equipment of the computing system 102 (for example, a storage device coupled by a communication network or a cable (not shown)). The I/O device 111 is an Ethernet (registered trademark) card, a Fibre Channel card, etc., and is provided with one or more ports (hereinafter called an I/O port) 112, for example. The above-mentioned external equipment is coupled to the I/O port 112.

In the present embodiment, a management system 184 which is operable to manage the computing system 102 as described above is provided. The management system 184 includes an I/O path evaluation system 101 and a management terminal 104 used as an I/O console of the I/O path evaluation system 101.

The I/O path evaluation system 101 possesses an I/O path evaluation CPU module 120 and a storage device 130. The I/O path evaluation system 101 is coupled to an external network 201, a storage device 202, a disk media 203, etc. From these items (the external network 201, the storage device 202, and the disk media 203), a computer program (an I/O path evaluating unit 123) which performs an I/O path evaluation processing is suitably loaded to a memory 122, then, the I/O path evaluating unit 123 is executed by a CPU 121. By the present scheme, the I/O path evaluation system 101 can perform an I/O path evaluation processing.

The I/O path evaluation system 101 receives OS area specification information 200 including an OS area ID (an OS area ID which is an identifier of an OS area explained later) designated by a manager 103 from the management terminal 104. Upon receiving the OS area specification information 200, the I/O path evaluation system 101 performs an I/O path evaluation processing and transmits I/O path evaluation result information 900 indicating the processing result to the management terminal 104. The I/O path evaluation result information 900 transmitted is displayed on a display device of the management terminal 104 for inspection by the manager 103.

The I/O path evaluation CPU module 120 is provided with the CPU 121 and the memory 122, serving as a main processor to perform the above-mentioned I/O path evaluation processing. The CPU 121 performs data processing of the I/O path evaluating unit 123 loaded to the memory 122. The memory 122 stores temporarily the I/O path evaluating unit 123 loaded. The I/O path evaluating unit 123, upon data-processed by the CPU 121, accesses the storage device 130 and performs the I/O path evaluation processing.

The storage device 130 stores I/O node information 600, I/O path information 700, and OS area information 800. These pieces of the information 600, 700, and 800 are information necessary when the I/O path evaluating unit 123 performs the I/O path evaluation processing. At least one of these pieces of the information 600, 700, and 800 may be the information acquired from the computing system 102, or may be the information inputted by the manager 103 via the management terminal 104. In the former case, specifically, for example at least one of the I/O node information 600, the I/O path information 700, and the OS area information 800 is stored in a storage resource managed by the computing system 102 (for example, a memory 107 in the CPU module 105 or a not-shown memory in the I/O path switchover device 108). A management module which exists in the inside or outside of the computing system 102 may receive an information acquisition request from the I/O path evaluation CPU module 120 and may transmit to the I/O path evaluation system 101 the information stored in the above-mentioned storage resource, responding to the information acquisition request.

Although the I/O path evaluation system 101 is described as an external system directly coupled to the computing system 102 in the present specification, the I/O path evaluation system 101 may be a part of the computing system 102 (namely, a system built in the computing system 102), or may be a remote system coupled to the computing system 102 via a communication network.

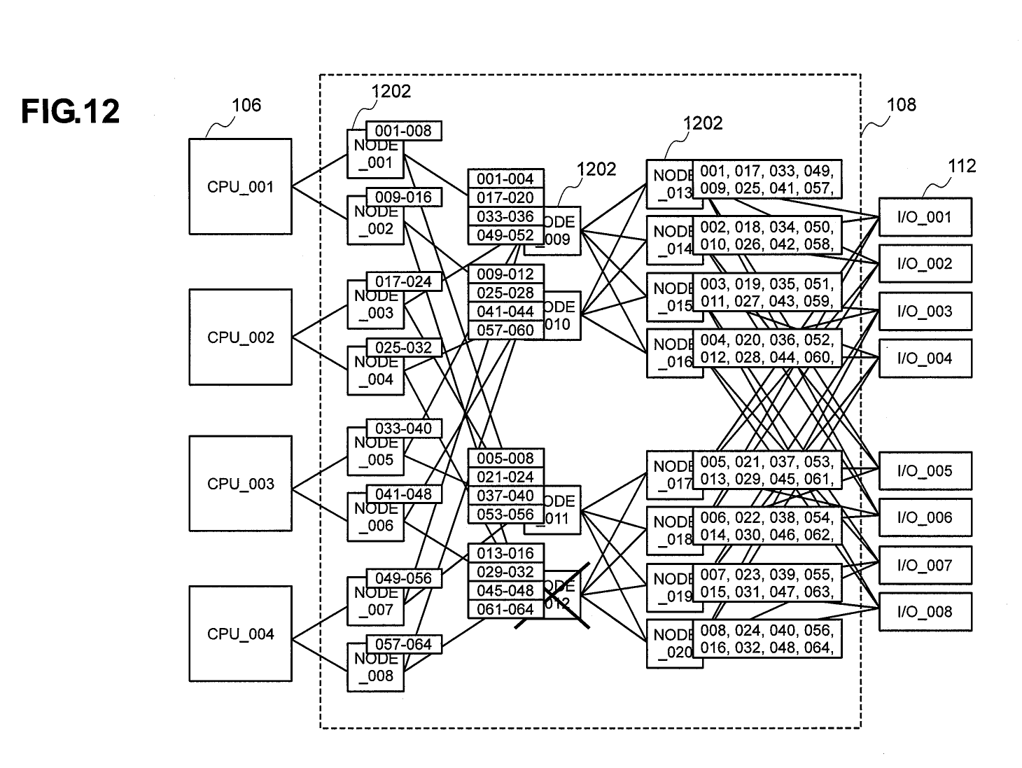

FIG. 12 is a diagram illustrating an example of constitution of the I/O switchover device 108. In the following explanation, the side of the CPU module 105 may be called an “upper side”, and the side of the I/O device 111 may be called a “lower side.”

As illustrated in FIG. 12, the I/O switchover device 108 includes plural components 1202 which possess a switching function. Between one component 1202 and another one or more components 1202, a physical link (for example, a lead printed on a circuit board or a cable) through which an electrical signal flows is provided. The construction of the plural components 1202 and plural links can be considered as a network. That is, the component which constitutes an I/O switchover device (for example, a module which includes a processor and functions as a switch) can be considered as a “node.” Hereinafter, the node is called an “I/O node.” Coupling of an I/O node 1202, locating at one end (the most anterior end) of an I/O path, to the CPU 106 defines the starting point of the I/O path as the CPU 106, while coupling of I/O node 1202, locating at the other end (the most posterior end) of an I/O path, to an I/O device 111 defines the end point of the I/O path as an I/O port 112 which the I/O device 111 possesses. In the present embodiment, it is possible that one I/O path may possess two or more I/O ports 112, each serving as an end point.

Next, the I/O node information 600, the I/O path information 700, and the OS area information 800 will be explained.

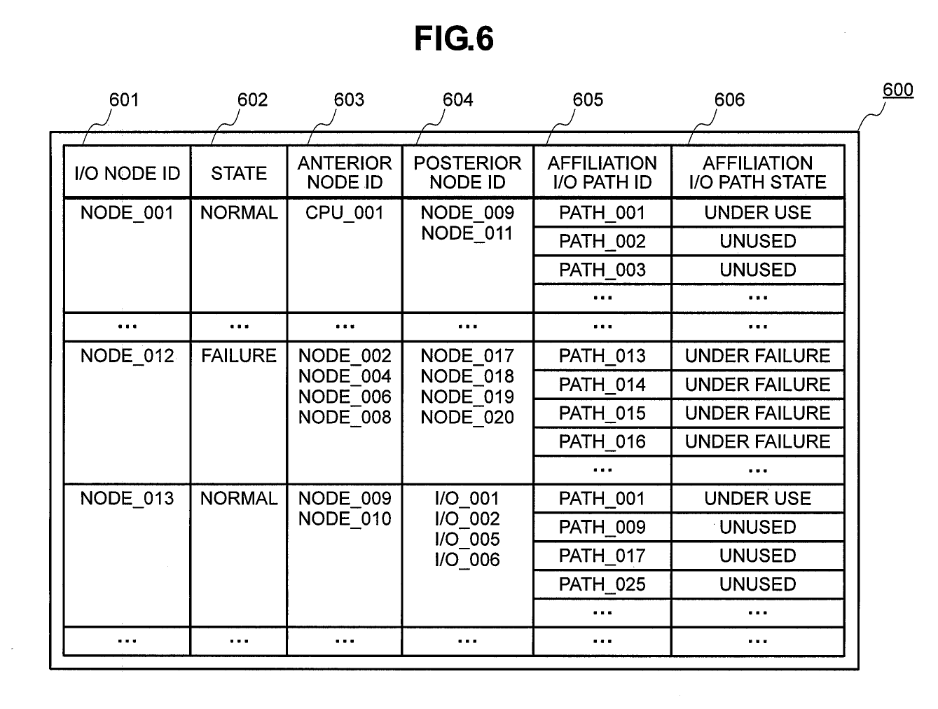

First, an example of constitution of the I/O node information 600 is explained with reference to FIG. 6. The I/O node information 600 of FIG. 6 is information corresponding to a case where the plural I/O switchover devices 108 are constructed as illustrated in FIG. 12. Hereinafter, for more intelligible explanation, FIG. 12 is also referred to suitably.

In the I/O node information 600, information about each I/O node which constitutes the internal network of the I/O path switchover device 108 is recorded. Specifically, as for one certain I/O node (hereinafter called “the I/O node concerned” for convenience of the explanation of FIG. 6), for example, the information about the I/O node concerned includes an I/O node ID 601 which is an identifier of the I/O node concerned, a state 602 which is information indicating the state of the I/O node concerned, an anterior node ID 603, a posterior node ID 604, an affiliation I/O path ID 605 which is an identifier of an I/O path to which the I/O node concerned belongs (for example, the most anterior node, a relay point node, or the most exterior node), and an affiliation I/O path state 606 which is information indicating the state of the affiliation I/O path.

The anterior node ID 603 is an identifier of an I/O node locating in upper side by one of the I/O node concerned. When the I/O node concerned is the most anterior I/O node of an I/O path, the anterior node ID 603 is an identifier of the CPU 106. Specifically, as seen from FIG. 12 for example, when the I/O node concerned is I/O node:001 (an I/O node whose I/O node ID 601 is “NODE_{—}001”), the device which exists in upper side by one of I/O node:001 is CPU:001 (a CPU whose identifier is “CPU_{—}001”). Therefore, the anterior I/O node ID 603 of the I/O node concerned is set to “CPU_{—}001” 106.

On the other hand, the posterior node ID 604 is an identifier of an I/O node locating in lower side by one of the I/O node concerned. When the I/O node concerned is the most posterior I/O node of an I/O path, the posterior node ID 604 is an identifier of the I/O port 112. Specifically, as seen from FIG. 12 for example, when the I/O node concerned is I/O node:013, the device which exists in lower side by one of I/O node:013 is I/O port:001 (an I/O port 112 whose identifier is “I/O_{—}001”), 002, 005 and 006. Therefore, the posterior I/O node ID 604 of the I/O node concerned is set to “I/O_{—}001” “I/O_{—}002”, “I/O_{—}005”, and “I/O_{—}006.”

The above is explanation about the I/O node information 600. In FIG. 12, the symbol in the block indicating the I/O node 1202 indicates the identifier of the I/O node 1202 (the same for the CPU 106 and the I/O port 112). The identifiers written in a block overlapping the block indicating the I/O node 1202 indicate the identifiers of the I/O paths which go through the I/O node 1202. Specifically, for example, eight I/O paths of from I/O path:001 (I/O path whose identifier is “PATH_{—}001”) to I/O path:008 belong to node:001, and eight I/O paths of I/O path:001, I/O path:017, I/O path:033, 1/O path:049, I/O path:009, I/O path:025, I/O path:041, and I/O path:057 go through node:013.

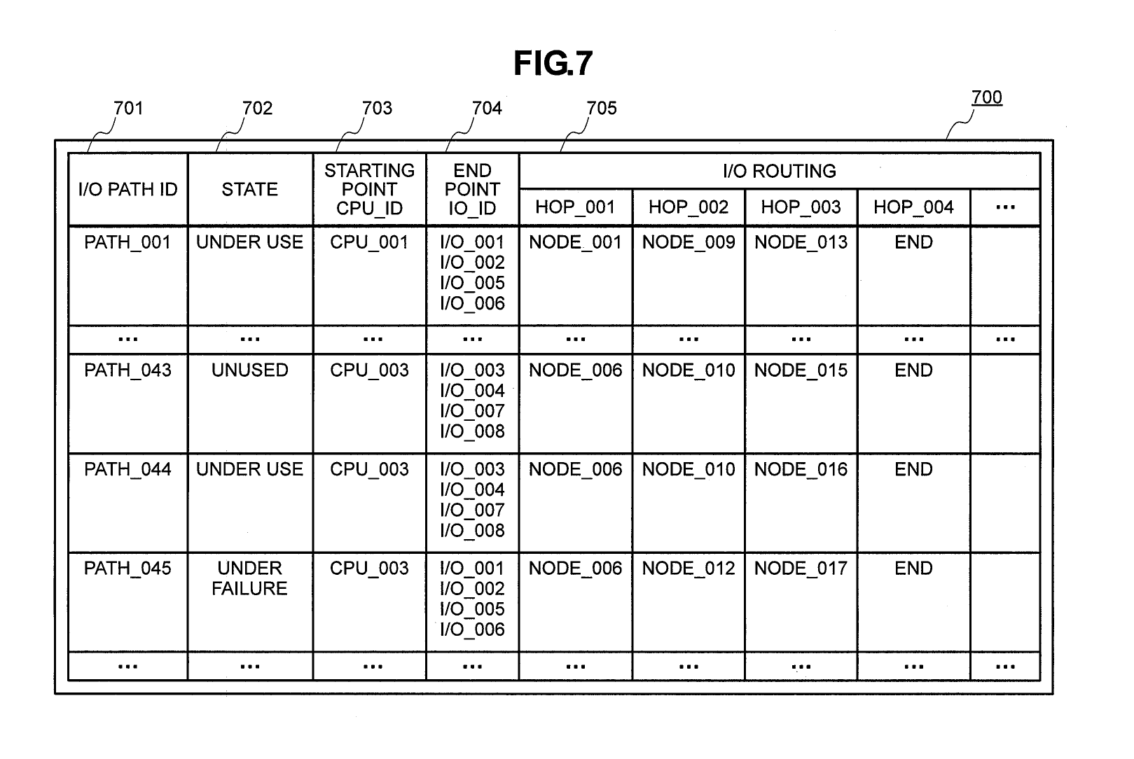

Next, the example of constitution of the I/O path information 700 is explained with reference to FIG. 7.

The I/O path information 700 is also information corresponding to the case where the entire structure of the internal network is constructed as illustrated in FIG. 12. That is, the I/O path information 700 of FIG. 7 is information about an I/O path, in contrast to the I/O node information 600 of FIG. 6 which is information about an I/O node. However, the contents of the both are substantially the same. Therefore, the I/O path information 700 may be created by the I/O path evaluating unit 123 by converting the form of the I/O node information 600, for example. Conversely, the I/O node information 600 may be created by converting the form of the I/O path information 700.

The information about each I/O path defined by a line of two or more nodes 1202 out of the plural nodes 1202 which constitute the internal network is recorded in the I/O path information 700. Specifically, as for one certain I/O path (hereinafter called “the I/O path concerned” for convenience of the explanation of FIG. 7), for example, the information about the I/O path concerned includes an I/O path ID 701 which is an identifier of the I/O path concerned, a state 702 which is information indicating the state of the I/O path concerned, a starting point CPU-ID 703 which is an identifier of the CPU 106 serving as the starting point of the I/O path concerned (in other words, the CPU 106 coupled to the most anterior node of the I/O path concerned), an end-point I/O-ID 704 which is an identifier of the I/O port 112 serving as the end-point of the I/O path concerned (in other words, an I/O port 112 possessed by the I/O device 111 coupled to the most posterior node of the I/O path concerned), and an I/O routing 705. The I/O routing 705 is information indicating the constitution of the I/O path concerned, in particular, the identifier of each I/O node in the way followed from the starting point CPU 106 to the end-point I/O port 112, arranged in order (“END” is recorded at the end to illustrate termination).

Three kinds of states, “under use”, “unused”, and “under failure”, are illustrated as the state 702 in FIG. 7 (and as the affiliation I/O path state 606 in FIG. 6).

“Under use” means that the I/O path concerned is currently used. In particular, “under use” means that the command and data issued from the CPU 106, to which the I/O path concerned is assigned, flow through the I/O path concerned. The I/O path concerned which is “under use” is an I/O path allocated to an OS area (hereinafter called “allocation I/O path”).

“Unused” means that the I/O path concerned is associated with the CPU 106 belonging to the OS area, but in fact, the I/O path concerned is an un-allocated I/O path (a candidate for an allocation I/O path). In other words, “unused” means that even if a command is issued from the CPU 106, the command does not flow through the I/O path concerned. When the state 702 of the I/O path currently allocated to the OS area changes from “under use” to “under failure”, the state 702 of the I/O path concerned may be switched from “unused” to “under use.”

“Under failure” means that the I/O node to which the I/O path concerned belongs is under failure.

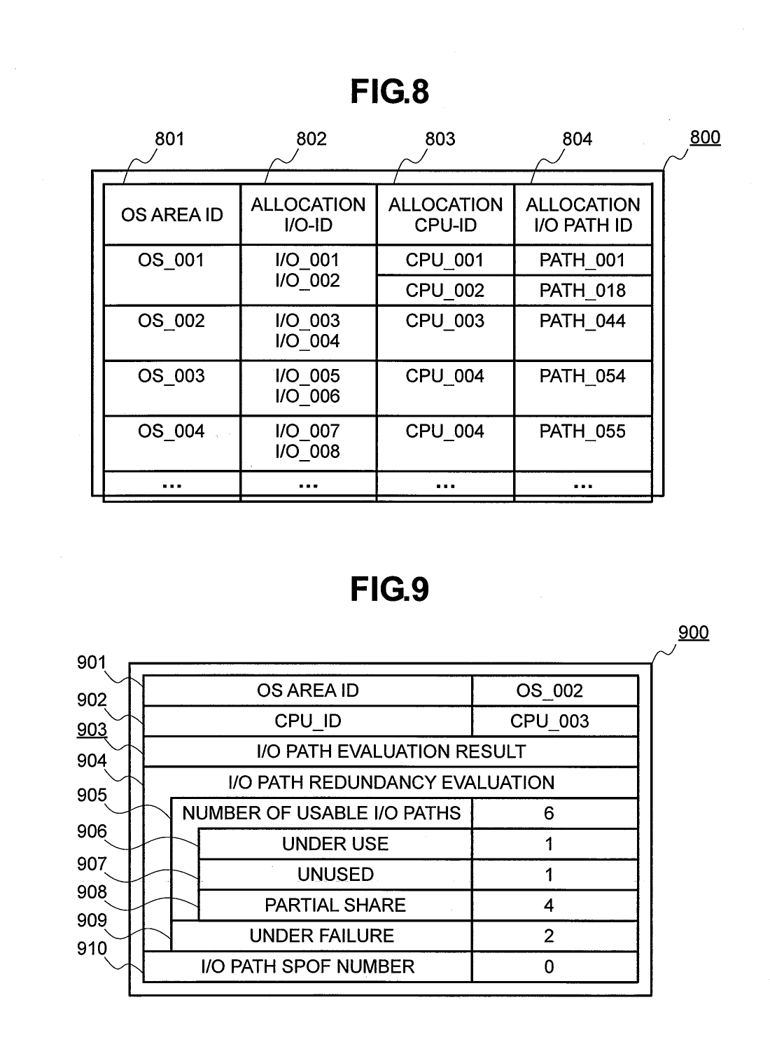

Next, the example of constitution of the OS area information 800 is explained with reference to FIG. 8.

In the present specification, an OS area is a computation region constituted by using technology generally referred as physical partitioning technology, logical partitioning technology, SMP (Symmetric Multiple Processor) technology, etc. A computation region is an area covering the entire or a part of the plural combined CPU modules 105. A part of the plural combined CPU modules 105 is the entire or a part of one CPU module 105. Since the I/O port 112 and the I/O path are also allocated per OS area, it is possible to specify a CPU, an I/O port, and an I/O path which are used in I/O path evaluation processing by determining an OS area uniquely as an object of the I/O path evaluation processing. That is, determining the OS area means specifying the combination of a CPU and an I/O port, and a group of the I/O paths which couples between them.

The OS area information 800 stores the allocation information to the CPU 106, the I/O port 112, and OS (Operating System) of an I/O path. In particular, for example, as for one certain OS area (hereinafter called “the OS area concerned” for convenience of the explanation of FIG. 8), the allocation information on the OS area concerned includes an OS area ID 801 which is an identifier of the OS area concerned, an allocation I/O-ID 802 which is an identifier of the I/O port 112 allocated to the OS area concerned, an allocation CPU-ID 803 which is an identifier of a CPU allocated to the OS area concerned, and an allocation I/O path ID 804 which is an identifier of the I/O path allocated to the OS area concerned. (The I/O path allocated to the OS area may be hereinafter called an “allocation I/O path”).

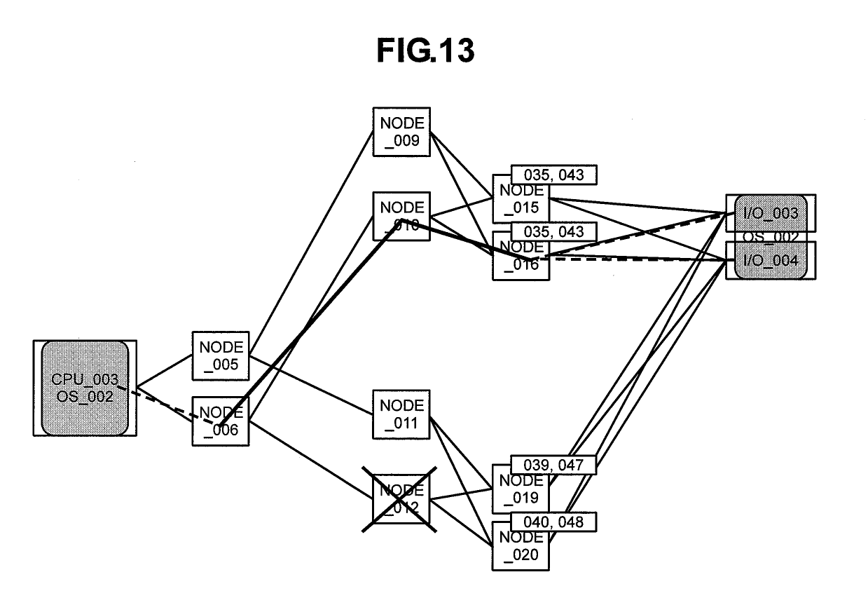

FIG. 13 illustrates a part of the constitution of the internal network illustrated in FIG. 12, or specifically, the part in connection with the OS area:002 (the OS area whose OS area ID 801 is “OS_{—}002”). In the following, with reference to FIG. 13, the processing performed by the I/O path switchover device 108 and the state 702 of an I/O path (and the affiliation I/O path state 606 in FIG. 6) are explained (in that case, FIG. 6, 7, or 8 are referred to suitably).

In FIG. 13, a block in which the identifier of the I/O path is recorded is superimposed on the upper right of the block of the most posterior I/O node. The identifier of the I/O path is an identifier of the I/O path which belongs to the most posterior I/O node of eight I/O paths allocated to CPU:003. Specifically, it is illustrated that I/O paths:035 and 043 belong to the most posterior I/O node:015.

The information illustrated in FIG. 6 through FIG. 8 is set in the storage region provided in the I/O path switchover device 108 (for example, every storage area which an I/O node possesses or the shared area of plural I/O nodes). Based on the information, various kinds of processing are performed by the I/O path switchover device 108.

For example, CPU:003 is allocated to OS area:002 and I/O path:044 is allocated to CPU:003 (I/O path:044 is illustrated by a thick line in FIG. 13). Accordingly, a command issued from CPU:003 is sent via I/O path:044 to the end-point I/O port:003, 004, 007, or 008 of the I/O path:044 (namely, the most anterior I/O node:006 transfers the command to a relay point I/O node:010, the relay point I/O node:010 transfers the command to the most posterior I/O node:015 and the most posterior I/O node:015 transfers the command to the end-point I/O port:003, 004 and 007, or 008.

When the state 702 of I/O path:044 becomes “under failure” for example, the state 702 of an I/O path selected from one or more I/O paths of which the state 702 is “unused” is switched from “unused” to “under use” (for example, when a failure occurs in one of I/O nodes to which I/O path:044 belongs, an allocation I/O path is switched from I/O path:044 to I/O path:043).

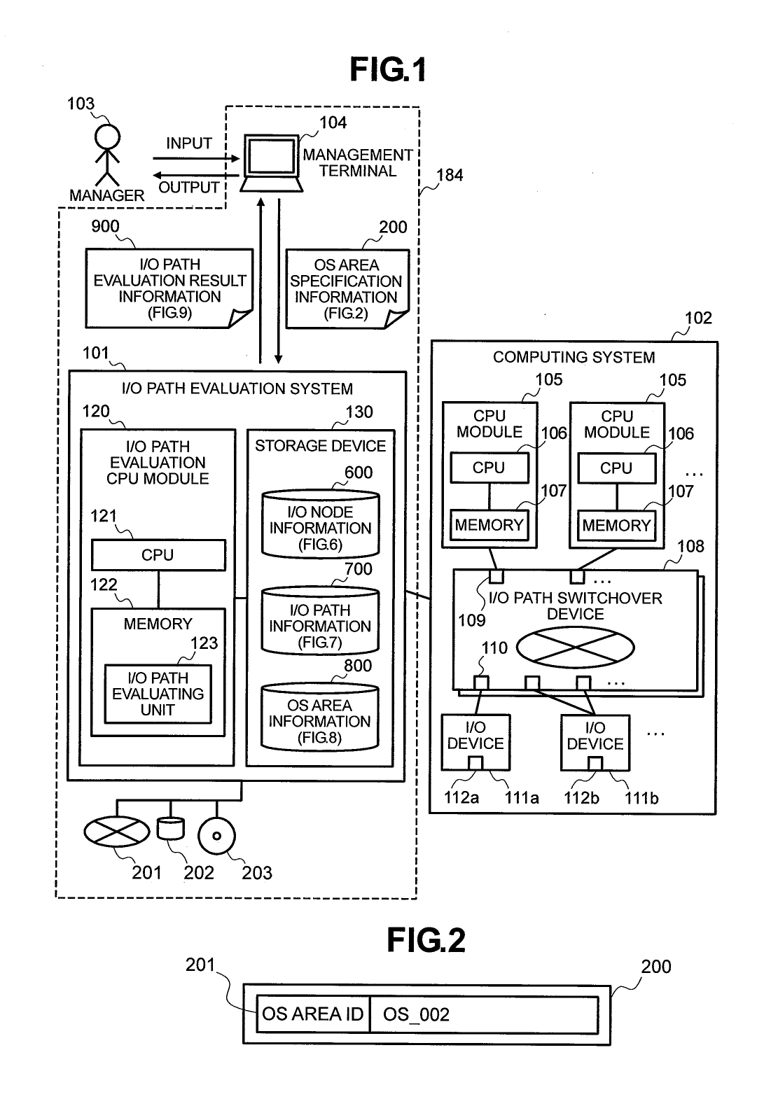

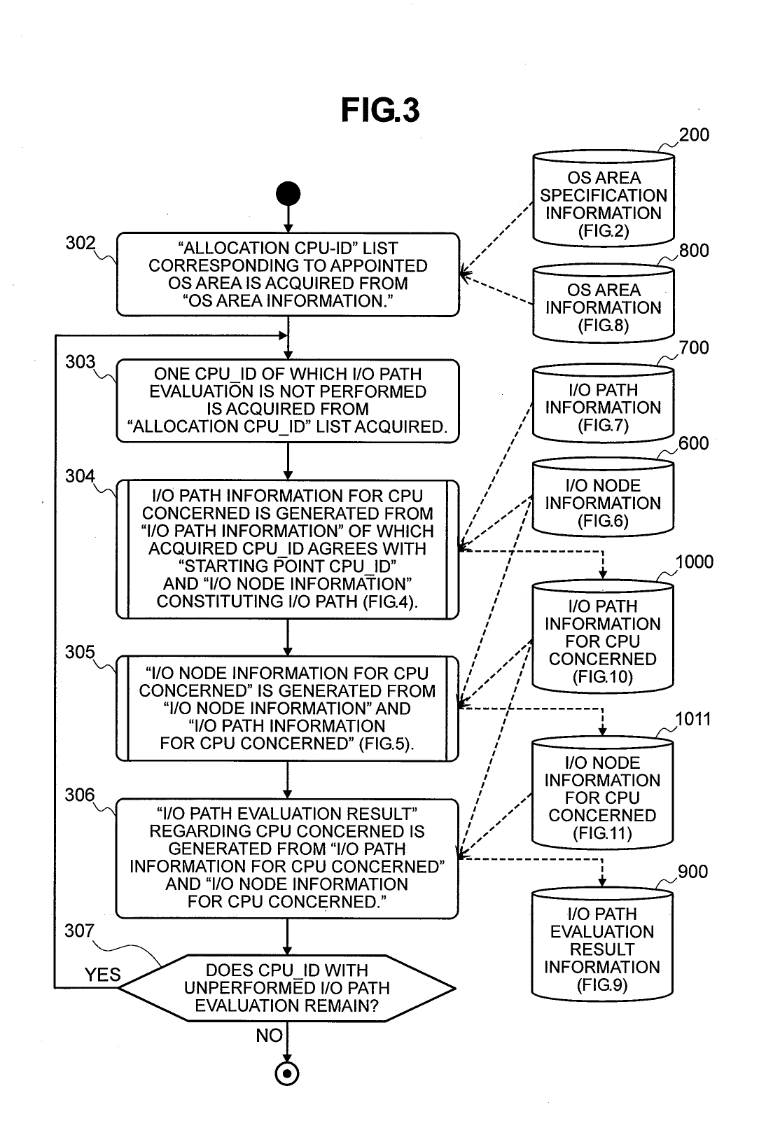

FIG. 2 is a chart illustrating an example of constitution of the OS area specification information 200. FIG. 2 illustrates a case where the manager 103 has selected arbitrarily an OS area ID “OS_{—}002” from plural OS area IDs 801 of the OS area information 800. Although FIG. 2 illustrates a case where one OS area ID 801 is selected, plural OS area IDs 801 may be selected. The management terminal 104 transmits, at the direction of the manager 103, the request of displaying the list of OS areas to the I/O path evaluating unit 123 of the I/O path evaluation system 101. In response to the request, the I/O path evaluating unit 123 creates the list of OS area IDs 801 recorded in the OS area information 800, and transmits the created list of OS area IDs 801 to the management terminal 104 (the kind of OS may also be transmitted or the OS area information 800 itself may also be transmitted). The management terminal 104 displays the list of OS area IDs 801, and receives specification of the OS area ID 801 which the manager 103 desires. The management terminal 104 transmits the OS area specification information 200 including the OS area ID selected by the manager 103 to the I/O path evaluation system 101.

FIG. 3 is a flow chart illustrating a flow of processing performed by the I/O path evaluating unit 123 upon receiving the OS area specification information 200. In the following explanation, it is arbitrarily assumed that an appointed OS area is OS area:002.

When receiving the OS area specification information 200 shown in FIG. 2 from the management terminal 104, the I/O path evaluating unit 123 acquires the list of allocation CPU-ID 803 corresponding to an appointed OS area (for example, “CPU-003”) from the OS area information 800 shown in FIG. 8 (Step S302).

The I/O path evaluating unit 123 acquires one allocation CPU-ID 803 for which an I/O path evaluation processing is not yet performed, from the list of the acquired allocation CPU-ID 803 (Step S303), and starts an I/O path evaluation processing with respect to the CPU 106 (hereinafter, the CPU 106 is called “the CPU concerned” for convenience of the explanation of FIGS. 3, 4, and 5) corresponding to the allocation CPU-ID 803 acquired (Step S304, Step S305, and Step S306).

In the I/O path evaluation processing, the I/O path evaluating unit 123 first generates I/O path information 1000 for the CPU concerned, with reference to the I/O path information 700 and the I/O node information 600, using the acquired allocation CPU-ID 803 (for example, “CPU_{—}003”) (Step S304).

Next, the I/O path evaluating unit 123 generates I/O node information 1100 for the CPU concerned with reference to the I/O node information 600 and the I/O path information 1000 for the CPU concerned generated at Step S304 (Step S305). The I/O path evaluating unit 123 generates I/O path evaluation result information 900 with reference to the generated I/O path information 1000 for the CPU concerned and the I/O node information 1100 for the CPU concerned (Step S306).

When the I/O path evaluation processing is completed with respect to the CPU concerned at the above-mentioned Steps S304-S306, the I/O path evaluating unit 123 determines whether any allocation CPU-ID for which the I/O path evaluation processing is not yet performed exists among the list of the allocation CPU-ID 803 acquired at Step S302 (Step S307). When one or more un-performed allocation CPU-IDs exist (“YES” at Step S307), the I/O path evaluating unit 123 selects one of the un-performed allocation CPU-ID and performs the processing after Step S303 again. When no un-performed allocation CPU-ID exists (“NO” at Step S307), the I/O path evaluating unit 123 terminates a series of processing operation.

By the above-mentioned processing operation, it is possible to perform evaluation about the I/O path associated with the CPU (that is, the CPU as the starting point) currently allocated to the OS area which is specified by the OS area specification information 200 received at Step S301.

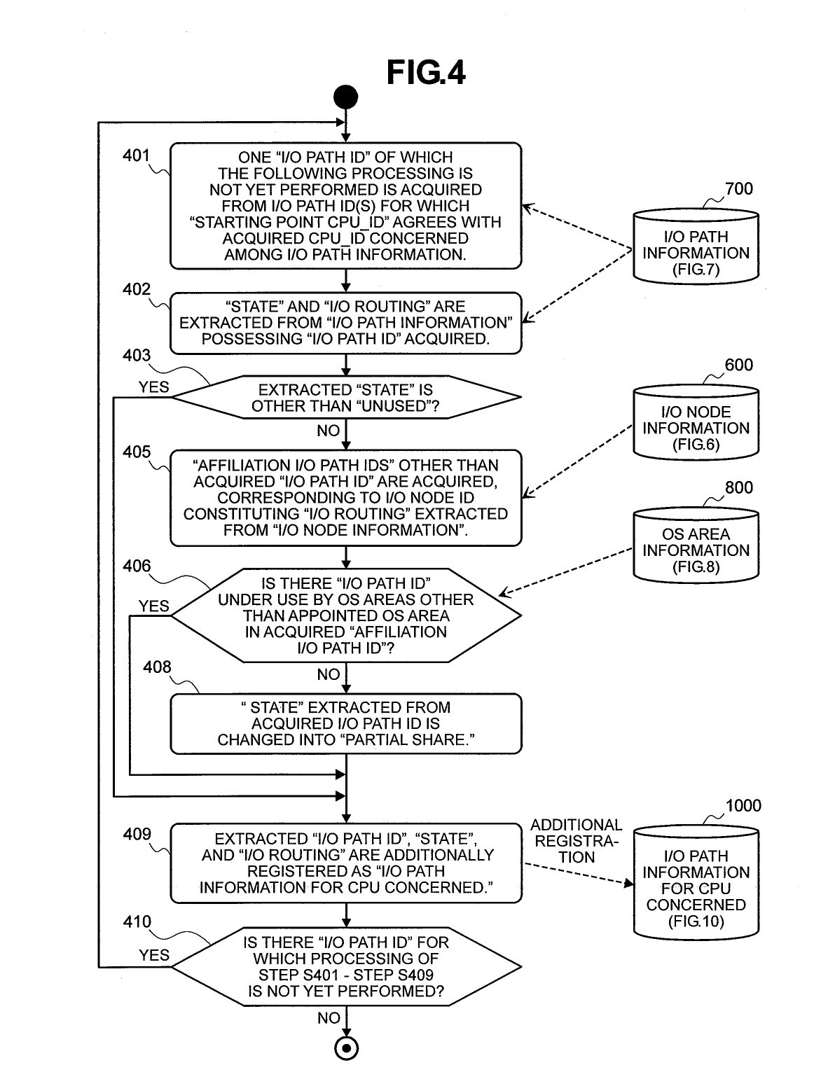

FIG. 4 is a flow chart illustrating the flow of the processing for generating the I/O path information 1000 for the CPU concerned at Step S304 of FIG. 3.

The I/O path evaluating unit 123 acquires one I/O path ID 701 (for example, “PATH-043”) of which the processing of Step S304 is not yet performed, from one or more I/O path IDs 701 (for example, “PATH_{—}043”, “PATH_{—}044”, etc.) for which the identifier of the CPU concerned is the starting point CPU-ID 703 (for example, “CPU-003”), among the I/O path information 700 (Step S401).

Next, the I/O path evaluating unit 123 extracts the state 702 and the I/O routing 705 corresponding to the I/O path ID 701 acquired at Step S401 from the I/O path information 700 (Step S402).

When the state 702 is other than “unused” as a result of extracting at Step S402 (Step S403), the I/O path evaluating unit 123 performs processing after Step S409. On the other hand, when the state 702 is “unused” as a result of extracting at Step S402 (Step S404), the I/O path evaluating unit 123 acquires all of the affiliation I/O path IDs 605 (however, the affiliation I/O path IDs 605 other than the I/O path ID 701 acquired at Step S401) corresponding to the I/O node ID which constitutes the I/O routing 705 extracted at Step S402 from the I/O node information 600 (Step S405).

Next, referring to the OS area information 800, the I/O path evaluating unit 123 determines whether any I/O path of which the affiliation I/O path state 606 is “under use” exists in the OS areas (for example, OS area:001, 003, etc.) other than the appointed OS area (for example, OS area:002), among the list of affiliation I/O path IDs 605 acquired at Step S405 (Step S406). In other words, the I/O path evaluating unit 123 determines whether the allocation I/O path ID 804 is associated with the CPU 106 (for example, CPU:001, 002, 004, etc.) currently allocated to the OS areas other than the appointed OS area, and whether the affiliation I/O path ID 605 which is in agreement with the allocation I/O path ID 804 is included in the list of affiliation I/O path IDs 605 acquired at Step S405. That is, at Step S406, the state of the I/O path about OS areas other than the appointed OS area is referred to.

When there is no I/O path of which the affiliation I/O path state 606 is “under use” about OS areas other than the appointed OS area, as a result of determination at Step S406 (“YES” at Step S406), the I/O path evaluating unit 123 performs processing after Step S409.

On the other hand, when an I/O path of which the affiliation I/O path state 606 is “under use” is found to exist in OS areas other than the appointed OS area as the result of determination at Step S406 (“NO” at Step S406), the state 702 of the I/O path ID 701 acquired at Step S401 is changed to “partial share” (Step S408). Namely, among “under use”, “unused”, “under failure”, and “partial share”, “partial share” is the state which is detected by the I/O path evaluating unit 123 in the processing flow of FIG. 4.

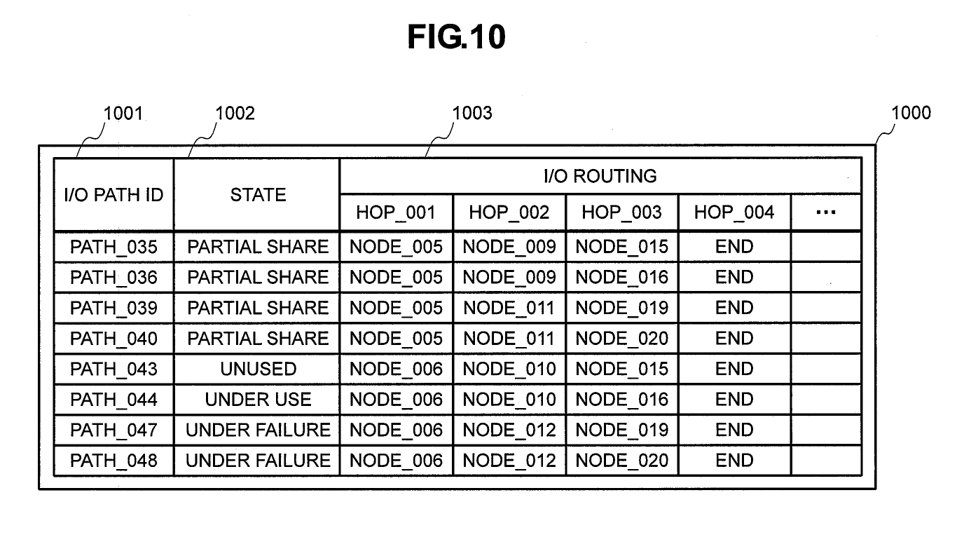

The state called as “partial share” means that when the state 702 of the I/O path concerned, which possesses a certain CPU 106 belonging to a certain OS area as the starting point, changes from “unused” to “under use”, at least one node is shared by the allocation I/O path belonging to another OS area. Accordingly, the I/O path of which the state is “partial share” is originally an I/O path of which the state is “unused”, and belongs to a node to which the allocation I/O path of an OS area different from an OS area belongs (hereinafter the OS area is called the appointed OS area), wherein the appointed OS area corresponds to the OS area ID 201 specified by the OS area specification information 200. Since the state called as “partial share” is detected in the processing flow of FIG. 4 as mentioned above, the value indicating “partial share” is not registered in the information shown in FIG. 6 or FIG. 7, but is registered as a state 1002 of the I/O path information 1000 for the CPU concerned, as shown in FIG. 10.

The I/O path evaluating unit 123 registers additionally the I/O path ID 701 acquired at Step S401, the state 702 corresponding to the I/O path ID 701, and the I/O routing 705 corresponding to the I/O path ID 701, as the new entry of the I/O path information 1000 for the CPU concerned (Step S409). If the present registration is the first registration and there is no I/O path information 1000 for the CPU concerned, the I/O path evaluating unit 123 can make the additional registration after creating the all-blank I/O path information 1000 for the CPU concerned.

Next, the I/O path evaluating unit 123 determines whether an I/O path ID 701 for which the processing of Step S304 is not yet performed remains in one or more I/O path IDs 701 in which the identifier of the CPU concerned is a starting point CPU-ID 703 (Step S410). When remaining (“YES” at Step S410), the I/O path evaluating unit 123 performs processing after Step S401, and when not remaining (“NO” at Step S410), Step S304 is terminated.

By performing the above-mentioned processing of FIG. 4 (that is, at the time when Step S304 of FIG. 3 is terminated), the I/O path information 1000 for the CPU concerned is perfected.

FIG. 10 is a chart illustrating an example of constitution of the I/O path information 1000 for the CPU concerned. Specifically, the I/O path information 1000 shown corresponds to the case where the CPU concerned is CPU:003. The I/O path information 1000 for the CPU concerned includes an I/O path ID 1001, a state 1002 of the I/O path, and an I/O routing 1003, as the information on the I/O path about the CPU concerned. The above items are the registered I/O path ID 701, state 702, and I/O routing 705, respectively.

From FIG. 13 and FIG. 10, the following fact can be understood. That is, eight I/O paths are coupled to the CPU:003 concerned. Among the eight I/O paths, the state 1002 of I/O path:047 and 048 is under failure, since I/O node:012 through which I/O path:047 and 048 go is “under failure”, and the other six I/O paths:035, 036, 039, 040, 043 and 044 are usable I/O paths. That is, a “usable I/O path” is an I/O path whose state 1002 is other than “under failure” (specifically, “under use”, “unused”, or “partial share”).

The I/O path information 1000 for the CPU concerned may be stored temporarily in the work area of the memory 122, etc. and may be deleted by the I/O path evaluating unit 123 after referred to at Step S305 and Step S306, for example.

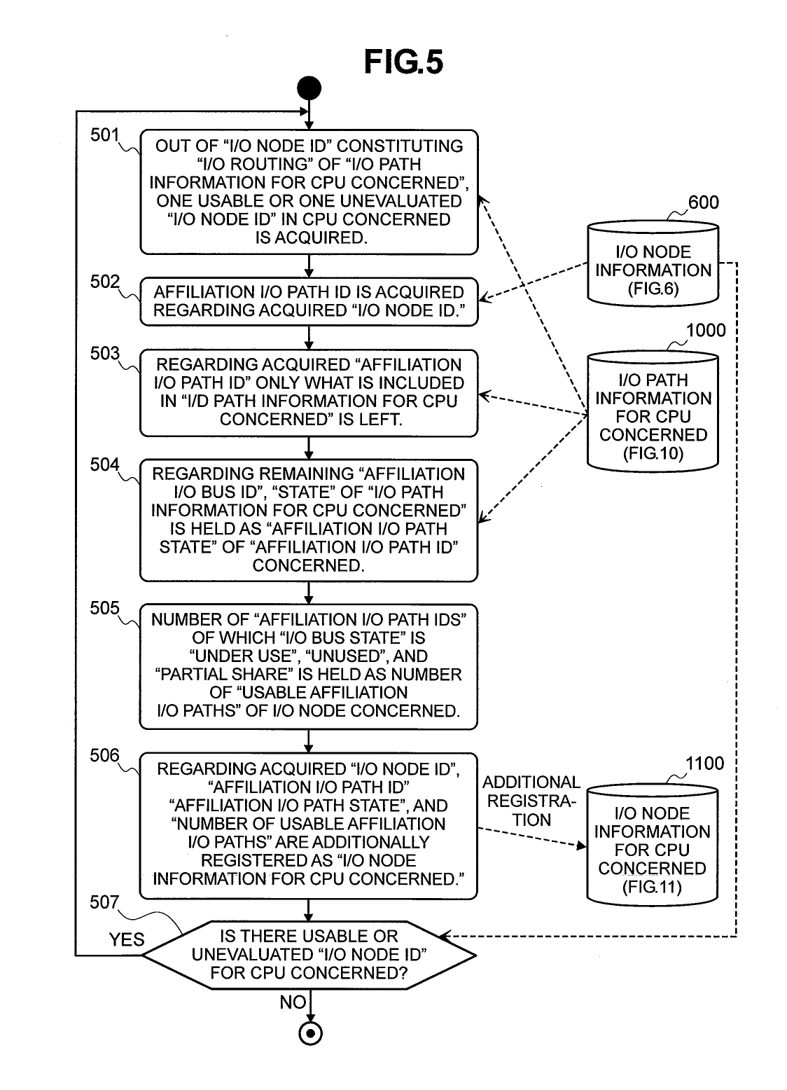

FIG. 5 is a flow chart illustrating a flow of the processing for generating the I/O node information 1100 for the CPU concerned at Step S305 of FIG. 3.

The I/O path evaluating unit 123 acquires one I/O node ID for which the processing of Step S305 of FIG. 3 is not yet performed, among the I/O node IDs which constitute the I/O routing 1003 of the I/O path information 1000 for the CPU concerned (Step S501).

Next, referring to the I/O node information 600, the I/O path evaluating unit 123 acquires all of the affiliation I/O path IDs 605 corresponding to the I/O node ID which is in agreement with the I/O node ID 601 acquired at Step S501, and stores them in the memory 122 (Step S502).

The I/O path evaluating unit 123 compares the list of affiliation I/O path IDs 605 acquired at Step S502 with the I/O path ID 1001 in the I/O path information 1000 for the CPU concerned, and leaves only affiliation I/O path ID 605 which is mutually in agreement in the memory 122 (Step S503).

The I/O path evaluating unit 123 stores in the memory 122 the state 1002 (affiliation I/O path state) corresponding to the I/O path ID 1001 which is mutually in agreement with the affiliation I/O path ID 605 left at Step S503 (Step S504).

The I/O path evaluating unit 123 stores in the memory 122 the information (the number of usable affiliation I/O paths) indicating the number of the affiliation I/O path IDs for which the affiliation I/O path state stored at Step S504 is one of “under use”, “unused”, or “partial share” (Step S505).

Next, the I/O path evaluating unit 123 registers additionally the I/O node ID acquired at Step S501, the affiliation I/O path ID 605 stored in the memory 122, the affiliation I/O path state, and the number of usable affiliation I/O paths, as a new entry of the I/O node information 1100 (Step S506). If the present registration is the first registration and there is no I/O node information 1100 for the CPU concerned, the I/O path evaluating unit 123 can make the additional registration, after creating the all-blank I/O node information 1100 for the CPU concerned.

The I/O path evaluating unit 123 determines whether the I/O node ID for which the processing of Step S305 is not performed remains in the I/O routing 1003 of the I/O path information 1000 for the CPU concerned (Step S507). When remaining (“YES” at Step S507), the I/O path evaluating unit 123 performs processing after Step S501 (Step S507), and when not remaining (“NO” at Step S507), a series of processing operations are terminated (Step S508).

By performing the above-mentioned processing of FIG. 5 (that is, at the time when Step S305 of FIG. 3 is terminated), the I/O node information 1100 for the CPU concerned is perfected.

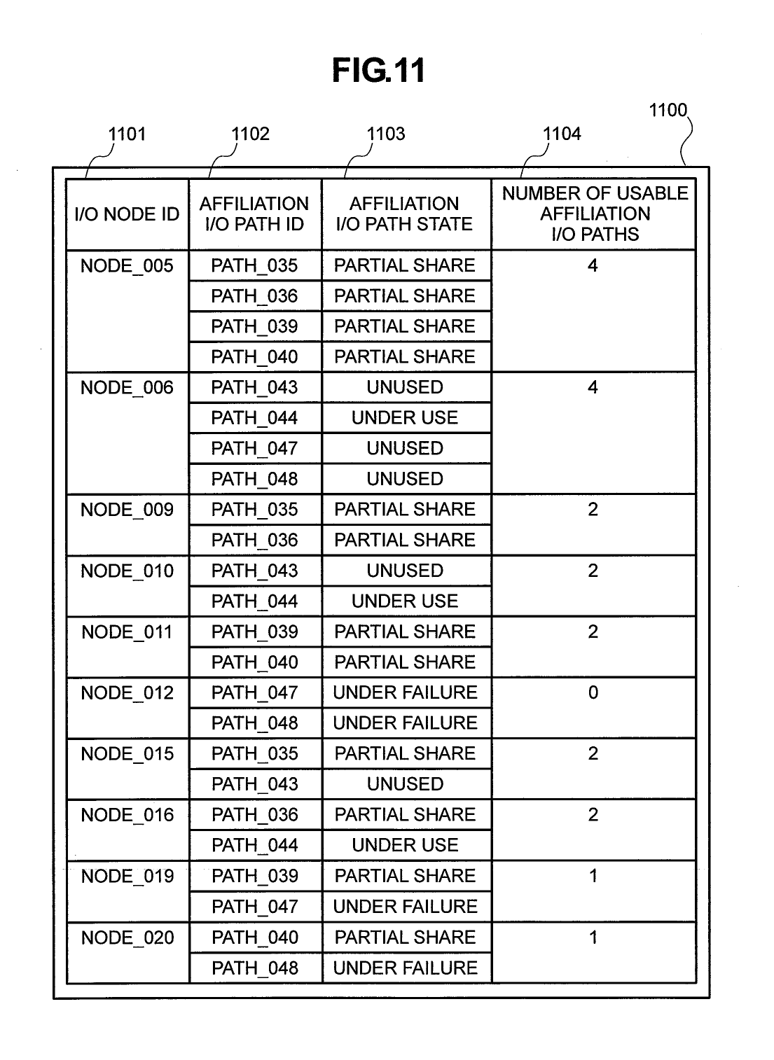

FIG. 11 is a chart illustrating an example of constitution of the I/O node information 1100 for the CPU concerned. Specifically, the I/O node information 1100 shown corresponds to the case where the CPU concerned is CPU:003.

The I/O node information 1100 for the CPU concerned includes an I/O node ID 1101, an affiliation I/O path ID 1102, an affiliation I/O path state 1102, and a number of usable affiliation I/O paths 1104, as information on each node which constitutes each I/O path coupled to the CPU concerned. The number of usable affiliation I/O paths 1104 is the information obtained in order to calculate the number of SPOF (single point of failure) about the CPU concerned.

The I/O node information 1100 for the CPU concerned may be stored temporarily in the work area of a memory 122, etc. and may be deleted by the I/O path evaluating unit 123 after referred to at Step S306, for example. The I/O node information 1100 of FIG. 11 may be created without creating the I/O path information 1000 of FIG. 10. However, it is expected to be able to create the I/O node information 1100 much faster by creating the I/O path information 1000 once and then creating the I/O node information 1100 using the I/O path information 1000 created.

FIG. 9 is a chart illustrating an example of constitution of I/O path evaluation result information 900. Specifically, the I/O path evaluation result information 900 shown corresponds to the case where the CPU concerned is CPU:003.

The I/O path evaluation result information 900 is the information generated with reference to the I/O path information 1000 for the CPU concerned which is generated at Step S304 and the I/O node information 1100 for the CPU concerned which is generated at Step S305.

The I/O path evaluation result information 900 comprises a CPU-ID 902 which is an identifier of CPU as the object for which the I/O path is evaluated (that is, the CPU concerned), and an evaluated result information element 903 which is an information element indicating the evaluation result. The I/O path evaluation result information 900 may include an OS area ID 901 which is an identifier of the OS area currently allocated to the CPU concerned. The I/O path evaluation result information 900 is sent to the management terminal 104, and is displayed by the management terminal 104. The manager can inspect the I/O path evaluation result information 900 and determine the suitable exchange timing of a failed object. In the present embodiment, the failed object to be exchanged may be only an I/O node under failure, or may be an I/O path switchover device 108 possessing the I/O node under failure.

The I/O path evaluation result information 900 is created in units of a CPU-ID or in units of the combination of an OS area ID and a CPU-ID. In particular, for example, the I/O path evaluation result information 900 corresponding to the CPU concerned may be created from the I/O path information 1000 for one piece of the CPU concerned, and the I/O node information 1100 for one piece of the CPU concerned. Alternatively, the I/O path evaluation result information 900 may be created from the I/O path information 1000 and the I/O node information 1100 respectively corresponding to plural CPU 106 to which the appointed OS area is allocated.

The I/O path evaluation result information element 903 includes the I/O path redundancy evaluation 904 and the I/O path SPOF number 910.

The I/O path redundancy evaluation 904 is information generated with reference to the I/O path information 1000. The I/O path redundancy evaluation 904 includes “under use” 906 indicating the number of the I/O paths for which the state 1002 is “under use”, “unused” 907 indicating the number of the I/O paths for which the state 1002 is “unused”, “partial share” 908 indicating the number of the I/O paths for which the state 1002 is “partial share”, and “under failure” 909 indicating the number of the I/O paths for which the state 1002 is “under failure.” The I/O path redundancy evaluation 904 also includes the number of usable I/O paths 905 that is the sum total of the number of I/O paths which are indicated by “under use” 906, “unused” 907, and “partial share” 908, respectively. By inspecting the I/O path redundancy evaluation 904, the manager can grasp the number of usable I/O paths, in other words, the redundancy of the present I/O path, as for CPU:003 to which the appointed OS area:002 is allocated. The I/O path evaluating unit 123 calculates “under use” 906, “unused” 907, “partial share” 908, “under failure” 909, and the number of usable I/O paths 905, with reference to the I/O path information 1000. However, as an alternative, the information included in the I/O path evaluation result information 900 (in other words, information which is displayed on the management terminal 104) may be only the number of usable I/O paths 905.

The I/O path SPOF number 910 is information generated with reference to the I/O node information 1100, and indicates the number of I/O node IDs 1101 for which the number of usable affiliation I/O paths 1104 of the I/O node information 1100 becomes equal to the number of usable I/O paths 905 calculated as described above. The I/O path SPOF number 910 is calculated when the I/O path evaluating unit 123 compares the number of usable affiliation I/O paths 1104 with the calculated number of usable I/O paths 905.

The fact that the number of usable affiliation I/O paths 1104 for a certain I/O node and the calculated number of usable I/O paths 905 are mutually in agreement means that all the usable I/O paths for CPU:003 belong to the certain I/O node, i.e., that the certain I/O node is a part which can become a single point of failure. By inspecting the I/O path SPOF number 910, the manager can know the number of the I/O nodes which can become a single point of failure for CPU:003 to which the appointed OS area:002 is allocated. Consequently the manager can grasp the reliability of the present I/O path.

According to the examples of FIGS. 9 and 11, although the number of usable I/O paths 905 is “6”, the maximum value of the number of usable affiliation I/O paths 1104 is “4.” Accordingly, the number of usable I/O paths 905 is mutually in agreement with neither of the number of usable affiliation I/O paths 1104, resulting in the I/O path SPOF number 910 of “0” as shown in FIG. 9.

However, when the number of usable I/O paths 905 is decreased from “6” to “4” and when two of the number of usable affiliation I/O paths 1104 possess the maximum value of “4” (namely, as is shown in FIG. 11), there are two of the number of usable affiliation I/O paths 1104 possessing the maximum value of “4” which are in agreement with the number of usable I/O paths 905 of “4”, resulting in the I/O path SPOF number 910 of “2.”

When the number of usable I/O paths 905 is further decreased from “4” to “2” for example, the maximum number of usable affiliation I/O paths 1104 becomes from “4” to less than or equal to “2.” This is because the maximum number of usable affiliation I/O paths 1104 never becomes larger than the number of usable I/O paths 905. In particular, for example, when the number of usable I/O paths 905 is decreased from “4” to “2”, and when the number of usable affiliation I/O paths 1104 is decreased from “4” to “2” with no other changes in FIG. 11, there are seven of the number of usable affiliation I/O paths 1104 possessing the maximum value of “2” which are in agreement with the number of usable I/O paths 905 of “2”, resulting in the I/O path SPOF number 910 of “7.”

In the above, the preferred embodiments of the present invention have been described. However, these embodiments are the mere examples for the explanation of the present invention, and do not mean that the range of the present invention is limited only to these embodiments. The present invention can be implemented with other various embodiments.

What is claimed is:

1. A management device for managing a computing system, the computing system comprising a processor module possessing a processor, an input/output device serving as a communication interface between the processor module and external equipment located outside the computing system, and a connection mechanism with a network including a plurality of switching units coupled with the processor module and the input/output device, the management device comprising:
an acquisition unit operable to acquire management information on a plurality of paths, each defined by a line of two or more switching units among the plurality of switching units;
a grasping unit operable to grasp path status by analyzing the management information acquired, and to create path status information on the path status grasped; and
an output unit operable to output the path status information.

2. The management device of claim 1,
wherein the management information includes information indicating which path a processor is associated with and information indicating a state of each path, and
wherein the grasping unit grasps redundancy as the path status based on a state of a path associated with the processor, and creates information including the redundancy as the path status information.

3. The management device of claim 2,
wherein the computing system possesses a plurality of processors;
wherein a usable state path includes a used state path and an unused state path;
wherein the unused state path can be switched to a used state path when a used state path becomes a failed state path,
wherein the grasping unit grasps, as the path status, a number of partially shared paths associated with a processor specified by information inputted by a manager, and creates information including the number of partially shared paths, as the path status information, and
wherein the partially shared path is an unused state path associated with the specified processor and belongs to a switching unit to which a used state path associated with the specified processor and an unrelated processor belongs.

4. The management device of claim 3,
wherein the unrelated processor is a processor assigned to a computation region different from a computation region assigned to the specified processor, and
wherein the computation region is the entire or a part of the plurality of processor modules.

5. The management device of claim 2,
wherein the grasping unit calculates a number of usable affiliation paths, which is a number of usable state paths to which each switching unit belongs and a number of usable state paths associated with the processor, separately for each switching unit belonging to each path associated with the processor, and the grasping unit creates, as the path status information, information including a number of single point of failure (SPOF number) defined by a number of switching units for which the number of usable state path associated with the processor agrees with the number of usable affiliation paths calculated.

6. The management device of claim 5,
wherein the management information includes information indicative of a state of each path of the plurality of paths, and information indicative of a line of two or more switching units belonging to a path,
wherein the grasping unit creates path information for the processor and switching unit information for the processor based on the path management information,
wherein the path information includes information indicative of a state of each path associated with the processor and information indicative of two or more affiliate switching units, and
wherein the switching unit information includes a state of each path to which each switching unit belongs and a number of usable affiliation paths calculated from the state of each path, for each switching unit specified by the path information.

7. The management device of claim 1,
wherein the management information includes information indicating which path a processor is associated with and information indicating a state of each path,
wherein the grasping unit calculates, as the path status, a number of usable affiliation paths, which is a number of usable state paths to which each switching unit belongs and a number of usable state paths associated with the processor, separately for each switching unit belonging to each path associated with the processor, and the grasping unit creates, as the path status information, information including a number of single point of failure (SPOF number) defined by a number of switching units for which the number of usable state path associated with the processor agrees with the number of usable affiliation paths calculated.

8. The management device of claim 1,
wherein the connection mechanism is a switching device, and
wherein the plurality of switching units are a plurality of switch-functioning components which constitute the switching device.

9. A management method for managing a computing system, the computing system comprising a processor module possessing a processor, an input/output device serving as a communication interface between the processor module and external equipment, and a connection mechanism with a network including a plurality of switching units coupled with the processor module and the input/output device are, the management method comprising:
acquiring management information on a plurality of paths, each defined by a line of two or more switching units among the plurality of switching units;
grasping path status by analyzing the management information acquired;
creating path status information on the grasped path status; and
displaying the created path status information.

10. A computer program for causing a computer to serve as a device for managing a computing system, the computing system comprising a processor module possessing a processor, an input/output device serving as a communication interface between the processor module and external equipment, and a connection mechanism with a network including a plurality of switching units coupled with the processor module and the input/output device, the computer program executable for causing a processor of the computer to perform steps of:
acquiring management information on a plurality of paths, each defined by a line of two or more switching units among the plurality of switching units;
grasping path status by analyzing the management information acquired;
creating path status information on the grasped path status; and
displaying the created path status information.

11. A computing system comprising:
a processor module possessing a processor;
an input/output device operable to serve as a communication interface between the processor module and external equipment;
a connection mechanism with a network including a plurality of switching units coupled with the processor module and the input/output device;
an acquisition unit operable to acquire management information on a plurality of paths, each defined by a line of two or more switching units among the plurality of switching units;
a grasping unit operable to grasp path status by analyzing the management information acquired, and to create path status information on the path status grasped; and
an output unit operable to output the path status information.
